(19) United States
(12) Patent Application Publication
(10) Pub. No.: US 2026/0028196 A1
(43) Pub. Date: Jan. 29, 2026

(54) EQUIPMENT SYNCHRONIZATION APPARATUSES WITH VARIABLE BREAKAWAY PRESSURES

(71) Applicant: Toyota Motor Engineering & Manufacturing North America, Inc., Plano, TX (US)

(72) Inventors: Robert A. Allex, Ewing, KY (US); Brian McElroy, Winchester, KY (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/783,591

(22) Filed: Jul. 25, 2024

(51) Int. Cl. B65G 69/16; F16F 1/12

(52) U.S. Cl. CPC B65G 69/16; F16F 1/121; B65G 2814/0205; F16F 2230/0005

(57) ABSTRACT

A method of tuning a breakaway force of a synchronization apparatus is provided. The method includes removing a first spring having a first spring constant from a breakaway portion of the synchronization apparatus, where the first spring constant causing the breakaway portion to pivot about a pivot axis relative to a fixed portion at a first breakaway force applied thereto. A second spring is mounted against the fixed portion. The second spring has a second spring constant causing the breakaway portion to pivot about the pivot axis at a second breakaway force that is different from the first breakaway force.

### TECHNICAL FIELD

The present specification generally relates to synchronization apparatus for equipment and, more specifically, to synchronization devices for synchronizing equipment to overhead conveyor lines.

### BACKGROUND

Dolly structures and other moving equipment may be used on an assembly line, such as a vehicle assembly line. It may be desirable to synchronize the equipment with a conveyor so that the equipment moves along the assembly line with the conveyor. Such a synchronized arrangement can facilitate an assembly operation on a structure moving with the conveyor.

What is needed are synchronization apparatuses for synchronizing movement of equipment with conveyors.

### SUMMARY

In one embodiment, a method of tuning a breakaway force of a synchronization apparatus is provided. The method includes removing a first spring having a first spring constant from a breakaway portion of the synchronization apparatus, where the first spring constant causing the breakaway portion to pivot about a pivot axis relative to a fixed portion at a first breakaway force applied thereto. A second spring is mounted against the fixed portion. The second spring has a second spring constant causing the breakaway portion to pivot about the pivot axis at a second breakaway force that is different from the first breakaway force.

In another embodiment, a synchronization apparatus includes a vertically-extending synchronization body including a fixed portion that is configured to be mounted to equipment and a breakaway portion that is hingedly connected to the fixed portion. A tether is connected to the breakaway portion and passes through an opening extending through the fixed portion, the tether extends through a spring that has one end engaged with the fixed portion and the tether is mounted against the opposite end of the spring. The spring is configured to bias the breakaway portion toward an upright position using the tether. The breakaway portion is configured to rotate relative to the fixed portion when a force is applied against the breakaway portion that overcomes a spring force of the spring.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic view of part of a synchronization apparatus synchronizing equipment with an overhead conveyor, according to one or more embodiments shown and described herein;

FIG. 2 is a diagrammatic view of the synchronization apparatus of FIG. 1 in isolation, according to one or more embodiments shown and described herein;

FIG. 3 is a diagrammatic view of a breakaway portion of the synchronization apparatus of FIG. 2, according to one or more embodiments shown and described herein;

FIG. 4 is a diagrammatic view of a fixed portion of the synchronization apparatus of FIG. 2, according to one or more embodiments shown and described herein; and

FIG. 5 illustrates a method of tuning a breakaway force of the synchronization apparatus of FIG. 1, according to one or more embodiments shown and described herein.

### DETAILED DESCRIPTION

Embodiments described herein are generally related to synchronization apparatuses that can be used to temporarily connect equipment, such as dollies, to conveyor lines so that the equipment can move along the conveyor line with an article of manufacture, such as a vehicle, for performing assembly operations. The synchronization apparatuses include a vertically-extending synchronization body including a fixed portion that is configured to be mounted to equipment and a breakaway portion that is hingedly connected to the fixed portion. A tether is connected to the breakaway portion and passes through an opening extending through the fixed portion. The tether extends through a compression spring that has one end engaged with the fixed portion and the tether is mounted against the opposite end of the spring. The breakaway portion rotates relative to the fixed portion when a force is applied against the breakaway portion that overcomes the spring force of the spring.

Embodiments described herein are also generally related to methods of tuning a breakaway force of a synchronization apparatus by removing a first spring having a first spring constant from the breakaway portion where the first spring constant causing the breakaway portion to pivot at above a first breakaway force and mounting a second spring against the fixed portion. The second spring applying a second force on the breakaway portion that is different from the first force where the second force causing the breakaway portion to pivot at above a second breakaway force different from the first breakaway force.

As used herein, the term “breakaway force” refers to the amount force required to cause the breakaway portion of the synchronization apparatus to pivot enough to release from the part of the conveyor it is engaged with during synchronization. The “spring force” is determined by Hooke's law, which is F=kx, where k is the spring constant of the spring.

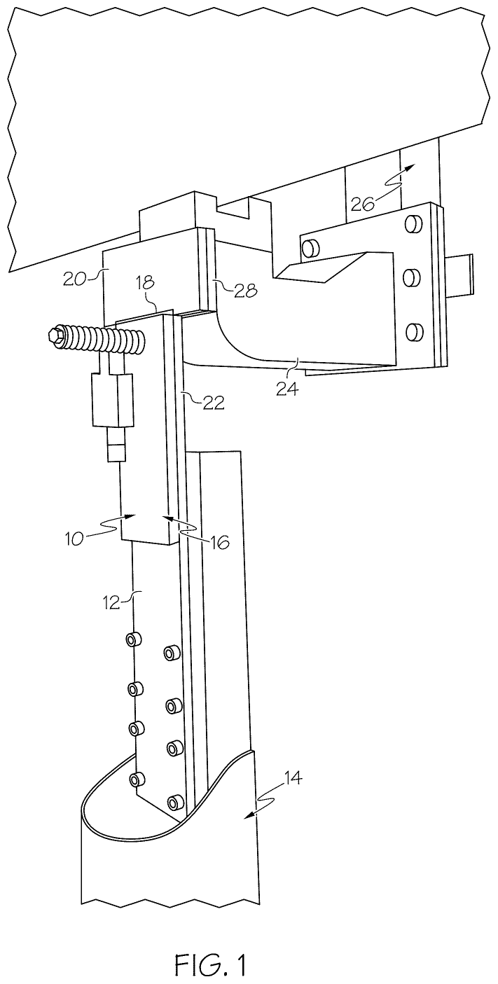

Referring to FIG. 1, a synchronization apparatus 10 is illustrated including a vertically-extending synchronization body including a fixed portion 12 that is mounted to an equipment 14, e.g., a dolly or cart and a breakaway portion 16 that is hingedly mounted to the fixed portion 12 by a hinge 18. The fixed portion 12 and the breakaway portion 16 may be plate-like bodies that are operatively mounted together. For example, the fixed portion 12 and the breakaway portion 16 may be formed of metal, wood, or any other suitable material.

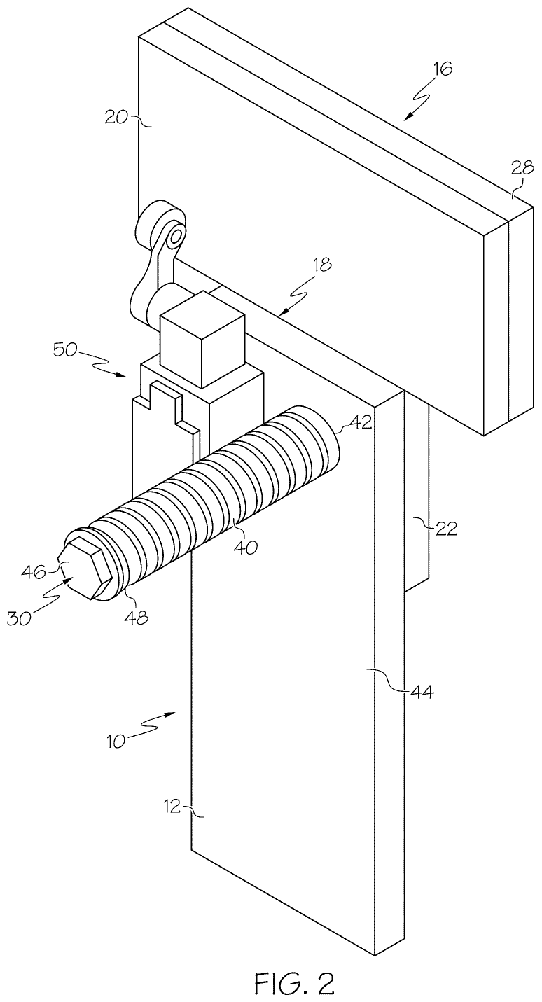

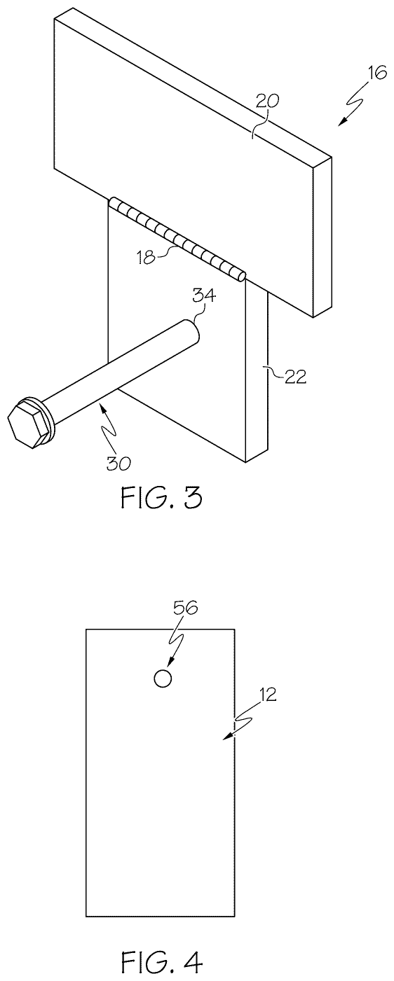

Referring also to FIGS. 2 and 3, the breakaway portion 16 includes an engagement portion 20 and a biasing portion 22 that extends outward from the engagement portion 20 at the hinge 18. The engagement portion 20 may be wider than the biasing portion 22 and be configured to engage a part 24 of a conveyor 26 (FIG. 1) as the part 24 travels along the conveyor 26. In some embodiments, the engagement portion 20 may include a pad 28 (e.g., a urethane pad) that can soften contact between the engagement portion 20 and the part 24.

A tether 30, best seen in FIG. 3 showing the breakaway portion 16 and tether 30 in isolation, is connected to the breakaway portion 16 using any suitable connection, such as a bolt 32. The tether 30 can be any suitable structure, such as a cable, rope, rod, etc. The tether 30 can be flexible, such as a cable or rope, semi-rigid, such as a rubber or plastic rod, or even rigid, such as a metal rod. The tether 30 is threaded through an opening 34 that extends through the biasing portion 22 and also another opening 36 that extends through the fixed portion 12 (FIG. 4).

Referring again to FIG. 2, the tether 30 is also threaded through a compression spring 40 that is engaged at an end 42 against the fixed portion 12 on an opposite side 44 from the biasing portion 22. The tether 30 is connected, e.g., by a bolt 46 or any other suitable connection, to an opposite end 48 of the spring 40. The spring 40 can pull on the tether 30, which also pulls on the biasing portion 22 at a location below the hinge 18 or pivot axis thereby biasing the breakaway portion 16 in the illustrated upright position providing a breakaway force. The breakaway portion 16 can remain in the upright position until the part 24 of the conveyor 26 exerts a force on the engagement portion 20 that exceeds the breakaway force provided by the spring 40. When the breakaway force provided by the spring 40 is exceeded, the breakaway portion 16 can pivot about the hinge 18 to a lowered position such that the synchronization apparatus 10 allows the part 24 of the conveyor 26 to move by without the equipment 14 synchronized therewith. A switch 50 or other sensing device may be provided, in this case mounted to the fixed portion 12, that can detect when the breakaway portion 16 pivots to a predetermined breakaway position and can provide a signal or turn off a signal that is used to shut down the conveyor 26 (FIG. 1).

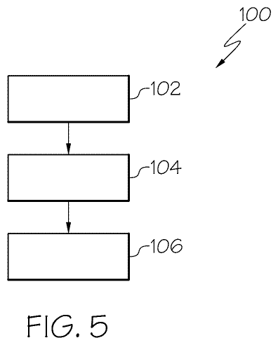

The spring 40 can be removed and replaced with another spring having a different spring constant k, which allows for tuning of the synchronization apparatus 10 based on the weight of the equipment being conveyed. Referring to FIG. 5, a method 100 of tuning a breakaway force of the synchronization apparatus 10 includes, at step 102, removing a first spring having a first spring constant applying a first force against the breakaway portion 16 where the first force causing the breakaway portion 16 to pivot at above a first breakaway force. At step 104, a second spring against the fixed portion 12 using the tether 30. The second spring applying a second force to the breakaway portion 16 at step 106 that is different from the first force where the second force causing the breakaway portion 16 to pivot at above a second breakaway force different from the first breakaway force.

The above-described synchronization apparatuses can allow for synchronization of equipment with an overhead conveyor as long as a force applied to the synchronization apparatuses does not exceed a predetermined amount, causing the synchronization apparatuses to break away from the conveyor. The predetermined amount of force calculation can depend on the weight of the equipment such that the heavier the equipment being synced, the greater the spring constant that may be selected and the lighter the equipment being synced, the lower the spring constant that may be selected. A simple turning of a bolt may be needed to release the current spring and then replace with another spring having a different spring constant. The breakaway portion can rotate relative to the fixed portion such that the synchronization apparatus releases from the overhead conveyor. Further, the switch or sensor can detect the rotation of the breakaway portion and provide a signal or lack of a signal that can be detected by a controller, which can then shut down the overhead conveyor or take some other action based on the input from the sensor.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method of tuning a breakaway force of a synchronization apparatus, the method comprising:
removing a first spring having a first spring constant from a breakaway portion of the synchronization apparatus, where the first spring constant causing the breakaway portion to pivot about a pivot axis relative to a fixed portion at a first breakaway force applied thereto; and
mounting a second spring against the fixed portion, the second spring having a second spring constant causing the breakaway portion to pivot about the pivot axis at a second breakaway force that is different from the first breakaway force.

2. The method of claim 1, wherein the second spring applying a biasing force to the breakaway portion toward an upright position.

3. The method of claim 2, wherein the biasing force is applied by a tether operatively connected to an end of the second spring, the second spring having an opposite end that is engaged with the fixed portion.

4. The method of claim 3, wherein the tether extends through the second spring and through an opening through the fixed portion, the tether connected to the breakaway portion.

5. The method of claim 4, wherein applying a biasing force comprises the second spring pulling the breakaway portion at a location below the pivot axis using the tether toward the upright position.

6. The method of claim 5, wherein the tether extending through another opening extending through the breakaway portion.

7. The method of claim 1, wherein the breakaway portion comprises an engagement pad configured to contact a part of a conveyor for synchronizing equipment with the conveyor.

8. A synchronization apparatus comprising:
a vertically-extending synchronization body including a fixed portion that is configured to be mounted to equipment and a breakaway portion that is hingedly connected to the fixed portion;
a tether is connected to the breakaway portion and passes through an opening extending through the fixed portion, the tether extends through a spring that has one end engaged with the fixed portion and the tether is mounted against the opposite end of the spring, the spring configured to bias the breakaway portion toward an upright position using the tether;
wherein the breakaway portion is configured to rotate relative to the fixed portion when a force is applied against the breakaway portion that overcomes a spring force of the spring.

9. The synchronization apparatus of claim 8, wherein the spring is configured to pull the breakaway portion at a location below a pivot axis using the tether toward the upright position.

10. The synchronization apparatus of claim 9, wherein the tether extends through another opening extending through the breakaway portion.

11. The synchronization apparatus of claim 8, wherein the breakaway portion comprises an engagement pad configured to contact a part of a conveyor for synchronizing equipment with the conveyor.

12. The synchronization apparatus of claim 8, wherein the tether is bolted to the opposite end.
